(19) United States
(12) Patent Application Publication
(10) Pub. No.: US 2012/0153520 A1
(43) Pub. Date: Jun. 21, 2012

(54) NEW-TYPE CHITOSAN-BASED HYBRID MACROMOLECULE AND A METHOD FOR PRODUCING OR USING THE MACROMOLECULE

(76) Inventors: Dean-Mo LIU, Hsinchu County (TW); Tsan-Hua Tung, Tainan City (TW); Hongwei Cheng, (US)

(21) Appl. No.: 13/101,676

(22) Filed: May 5, 2011

(30) Foreign Application Priority Data
Dec. 17, 2010 (TW) 99144446

(51) Int. Cl. B01J 13/02; C08B 37/08

(52) U.S. Cl. 264/4.6; 536/20

(57) ABSTRACT

The invention discloses the synthesis of a new-type chitosan-based hybrid macromolecule and a method for producing or using the macromolecule. This macromolecule comprises an amphiphatic chitosan and a silicon-based coupling agent that is anchored by a chemical bonding. The method for producing the hybrid macromolecule can be easily operated under ambient environment. The produced macromolecule can be self-assembled in an aqueous environment to form a nanocarrier, and has the ability to efficiently encapsulate drugs for a subsequent sustained release purpose. This self-assembled hybrid nanocarrier demonstrated features of excellent biocompatibility, drug loading ability and cellular uptake efficiency.

This application claims priority of Application No. 099144446 filed in Taiwan, R.O.C. on Dec. 17, 2010 under 35 U.S.C. §119, the entire contents of all of which are hereby incorporated by reference.

### FIELD OF THE INVENTION

The invention relates to a new-type chitosan-based hybrid macromolecule and a method for producing or using the macromolecule, especially relates to a new-type chitosan-based hybrid macromolecule that is self-assembled in an aqueous environment and has advantages of excellent biocompatibility, drug loading ability and cellular uptake efficiency.

### BACKGROUND OF THE INVENTION

A conventional drug carrier system mainly has two different mechanisms. One is to bind or adsorb a drug on a surface of a drug carrier, and the other is to package a drug inside of a drug carrier. The anterior way has lower drug loading ability and releases drug quickly. The later way is influenced by a selected material of a drug carrier that might be easily lead to drug leaking because of the fluid adsorption and swelling and might be difficult to control the drug release from the carrier.

Several popular drug carriers include liposome, transistor package, gelatin package and high-molecular micelle etc. The liposome technique packs a drug inside of a liposome, makes the drug release slowly and prevents the drug from reacting with enzymes of intestinal tract. However, am actual release time and release amount of the drug is difficult to estimate. The transistor package technique embeds a transistor has a drug inside at a tumor region tumor, makes the drug directly concentrate and act on tumor cells and decreases normal cell to be destroyed by the drug. But, an invasive surgery process is used to implant the transistor and patients need a period of time to recovery. The high-molecular micelle releases a drug slow release to a human body and can not concentrate the drug in a specific region.

### SUMMARY OF THE INVENTION

According to one aspect of an embodiment of the present invention is to provide a new-type chitosan-based hybrid macromolecule that is conjugated with an amphiphatic chitosan and a silicon-based inorganic coupling agent that is anchored by a chemical bond. The hybrid macromolecule is self-assembled in an aqueous environment to carry a drug and has features of excellent biocompatibility, higher drug loading ability and nice cellular uptake efficiency.

The hybrid macromolecule comprises an amphiphatic chitosan and a silicon-based inorganic coupling agent. The amphiphatic chitosan comprises a carboxymethyl group, is modified to have a hydrophilic terminal and a hydrophobic terminal, and is soluble in water or an acidic solution. The hydrophilic end is modified by a compound that is selected from a group comprises of carboxymethyl-contained molecule, polyethylene glycol (PEG), quaternary ammonium compounds and succinyl group. The hydrophobic end is modified by a compound that is selected from a group comprises of hexanoyl, polycaprolactone (PCL), cetyl group, palmitoyl group, cholesteryl group, phthalimido group and butyl glycidol ether. The silicon-based inorganic coupling agent is selected from a group comprises of 3-Aminopropyltrimethoxysilane (APTMS) and 3-aminopropyltriethoxysilane (APTES) and has at least an amino group in one end. In an embodiment, the carboxymethyl group of the amphiphatic chitosan and the amino group of the silicon-based inorganic coupling agent has a ratio by 1:0.01 to 1:20. In another embodiment, the amphiphatic chitosan is modified by a carboxymethyl group and a long-chain hexanoyl group.

The hybrid macromolecule in accordance with the present invention is self-assembled in an aqueous environment to form a micelle with diameter by 50 to 500 nanometers and the silicon-based inorganic coupling agent form a shell of the micelle, is continuous and highly layer-by-layered arrangement, and has crystallized atomic layer by 4 to 6 nanometers in thickness. The hybrid macromolecule has an internal hydrophobic force to induce atoms of the hybrid macromolecule self-organization and arrangement. Besides, the crystallized layer of the micelle is a physical barrier to reduce the carried drug leaking resulted from the hybrid macromolecule swelling in an aqueous environment.

According to another aspect of an embodiment of the present invention is to provide a method for producing a new-type chitosan-based hybrid macromolecule comprises step of preparing an organic and amphiphatic chitosan solution, preparing an organic and inorganic complex solution, and dialysis and drying. The concentration of the organic and amphiphatic chitosan solution is between 0.1 to 5%. The step of preparing an organic and inorganic complex solution further comprises a step of adding a catalyst into the organic and amphiphatic chitosan solution. The catalyst might be 1-ethyl-3-(3-dimethylaminopropyl) carbodiimide (EDC).

According to another yet aspect of an embodiment of the present invention is to provide a method for using a new-type chitosan-based hybrid macromolecule comprises step of preparing a drug solution and preparing a drug-contained micelle. The drug might be an anti-cancer drug, an anti-inflammation drug, an anti-hypertension drug, a diabetic drug, a protein drug, a peptide-based drug or a nucleotide. The drug solution might be diluted from a drug stock solution to a desired concentration by adding an optimal solvent depends on characteristics of the drug. In an embodiment, the drug micelle a has drug-loading ability by more than 80% and has excellent biocompatibility and cellular uptake efficiency.

The above objects and advantages of the present invention will become more readily apparent to those ordinarily skilled in the art after reviewing the following detailed descriptions and accompanying drawings in which:

### BRIEF DESCRIPTIONS OF THE DRAWINGS

The patent or application file contains at least one drawing executed in color. Copies of this patent or patent application publication with color drawing(s) will be provided by the Office upon request and payment of the necessary fee.

FIG. 1 is a structural formula of a new-type chitosan-based hybrid macromolecule in accordance with the present invention.

FIG. 2 is a flow chart illustrates steps that the chitosan-based hybrid macromolecule is self-assembled to form a nanocarrier.

FIG. 3 is an infrared spectra of the chitosan-based hybrid macromolecule in accordance with the present invention and an amphiphatic chitosan.

FIG. 4 is a ¹³C nuclear magnetic resonance spectrum of the chitosan-based hybrid macromolecule in accordance with the present invention and an amphiphatic chitosan.

FIG. 5 is a ²⁹Si nuclear magnetic resonance spectrum of the chitosan-based hybrid macromolecule in accordance with the present invention and an amphiphatic chitosan.

FIG. 6 is a scan electron microscopic photograph of the self-assembled macromolecule in accordance with the present invention.

FIG. 7 is a transmission electron microscopic photograph of the self-assembled macromolecule in accordance with the present invention.

FIG. 8 is a partially enlarged drawing of FIG. 7.

FIG. 9 is a diagram shows drug cumulative release amount of a drug micelle in accordance with the invention.

FIG. 10 is a diagram shows viability of human retinal pigment epithelium APRE-19 that is incubated with different concentration of the hybrid micelle.

FIG. 11A is a diagram shows viability of human retinal pigment epithelium APRE-19 that is incubated with hybrid micelle with different mole ratio of the carboxymethyl group and the amino group.

FIG. 11B is a diagram shows viability of human lung carcinoma A-549 that is incubated with hybrid micelle with different mole ratio of the carboxymethyl group and the amino group.

FIG. 11C is a diagram shows viability of the human breast carcinoma MCF-7 that is incubated with hybrid micelle with different mole ratio of the carboxymethyl group and the amino group.

FIG. 12 is photograph shows the cellular uptake efficiency of the drug-containing micelles.

### DETAILED DESCRIPTION OF THE PREFERRED EMBODIMENT

### Example 1

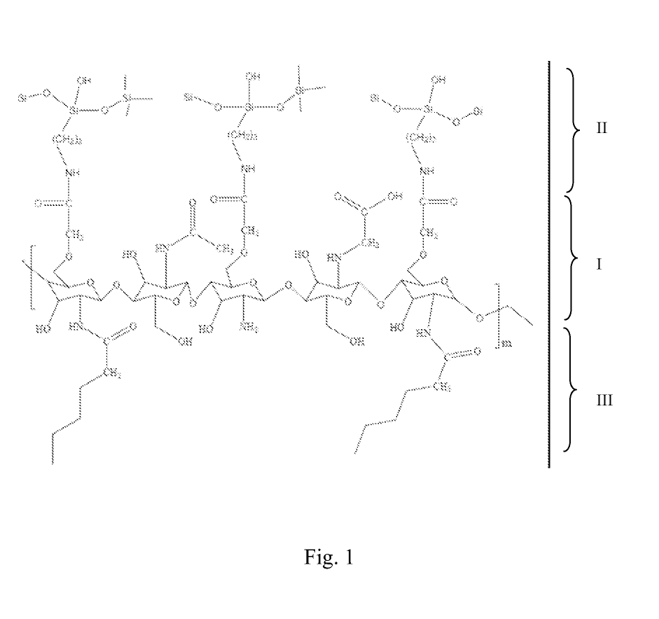

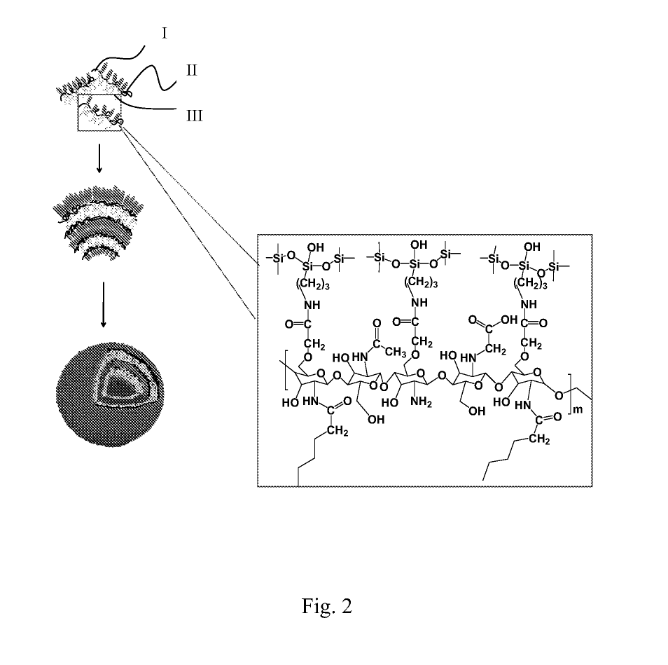

With reference to FIGS. 1 and 2, a new-type chitosan-based hybrid macromolecule in accordance with the present invention comprises an amphiphatic chitosan and a silicon-based inorganic coupling agent that is anchored by a chemical bond. The skeleton of the amphiphatic chitosan has a long carbon chain (I) and comprises a modified hydrophilic terminal (II) and a modified long-chain hydrophobic terminal (III). The hybrid macromolecule is an organic-inorganic hybrid molecule and is self-assembled in an aqueous environment to form a core-shelled micelle.

### Example 2

A method for producing a new-type chitosan-based hybrid macromolecule in accordance with the present invention uses 3-aminopropyltriethoxysilane (APTES) as the silicon-based inorganic coupling agent and comprises steps as following:

preparing an organic and amphiphatic chitosan solution: adding 0.25 grams organic and amphiphatic chitosan in 50 mL deionized water and stirring under ambient environment to form an organic and amphiphatic chitosan solution. The amphiphatic chitosan has a modified hydrophilic terminal and a modified hydrophobic terminal.

preparing an organic and inorganic complex solution: adding about 160 microleter (μL) inorganic APTES solution into the chitosan solution, stirring under nitrogen atmosphere and mixing well to form an organic and inorganic complex solution.

dialysis: placing the organic and inorganic complex solution in 75% (v/v) ethanol for 24 hours and then placing the organic and inorganic complex solution in a pure ethanol for 24 hours to get a dialysis product.

drying: drying the dialysis product in an oven to form the hybrid macromolecule.

In the step of preparing an organic and inorganic complex solution, the amphiphatic chitosan and the APTES is adjusted to the mole ratio of the carboxymethyl group of the amphiphatic chitosan and the amino group of the APTES by 1 (mole/mole). Further, a catalyst is added to increase the reaction between the amphiphatic chitosan and the APTES. The catalyst is 1-ethyl-3-(3-dimethylaminopropyl) carbodiimide (EDC) and the reaction amount is 0.012 grams.

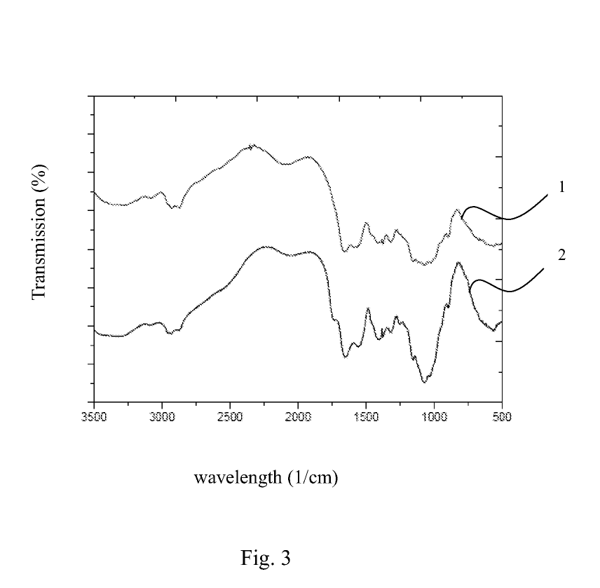

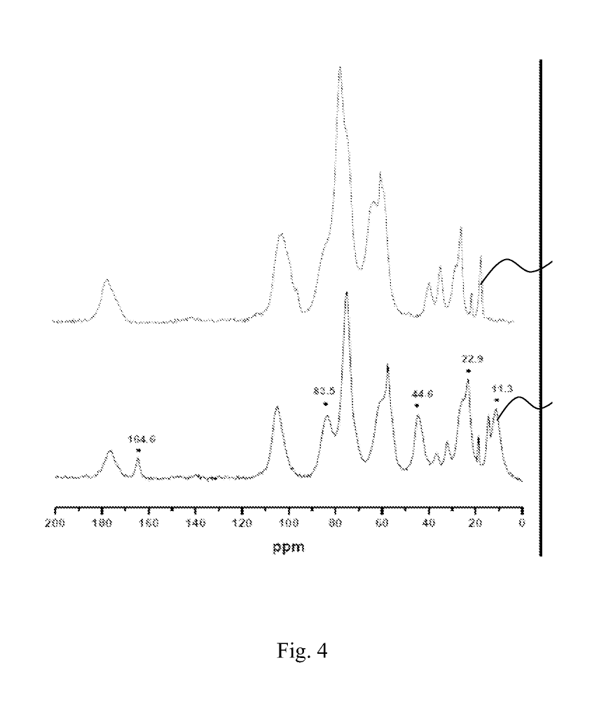

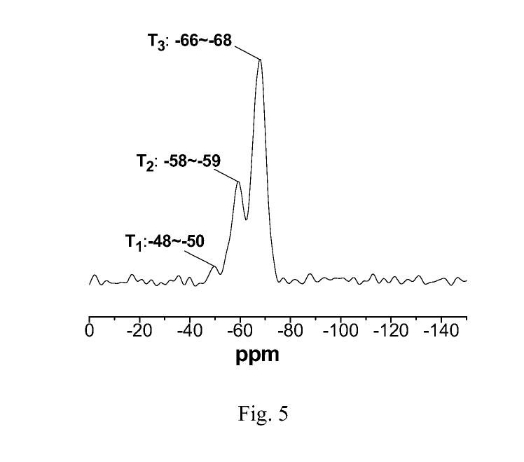

With reference with FIGS. 3 to 5, a frustrated total internal reflection (FTIR) diagram of the hybrid macromolecule and a conventional amphiphatic chitosan shows an O—H binding of a carboxymethyl group of the conventional amphiphatic chitosan has a stretching resonant peak at 1720 cm⁻¹ is disappeared after modifying by the silicon-based inorganic coupling agent. This indicates the carboxymethyl group of the amphiphatic chitosan reacts with the silicon-based inorganic coupling agent. Peaks at 2300-2360 cm⁻¹, 900-950 cm⁻¹ and 1100 cm⁻¹ respectively refer to C═N, Si—OH and Si—OH stretching resonant bands.

As comparing a ¹³C nuclear magnetic resonance spectrum of an embodiment of the chitosan-based hybrid macromolecule of the invention and an amphiphatic chitosan, the diagram of the macromolecule of the invention has peaks at 11, 23 and 44 ppm that are referred to a (CH₂)CH₃ carbon chain of an aliphatic group and a carbon chain of an ester group which is connected to the silicon atom of the silicon-based inorganic coupling agent. A peak at 160-170 ppm is generated by a amino-based compound that is contained a carbonyl group (C═O). Accordingly, the hybrid macromolecule is formed by anchoring the carboxymethyl group of the amphiphatic chitosan and the amino group of the silicon-based coupling agent.

A ²⁹Si nuclear magnetic resonance spectrum shows T1 (−48˜−50 ppm), T2 (−58˜−59 ppm) and T3 (−66˜−68 ppm) peaks are respectively referred to (SiO)Si(CH₂)₃(OH)₂, (SiO)₂Si(CH₂)₃OH and (SiO)₃Si(CH₂)₃ groups. The peak area of T2 and T3 is larger than T1 indicates most linked silane groups are hydrolyzed and condensed to from a Si—O—Si linkage and only fewer silane groups is exposed outside of the hybrid macromolecule.

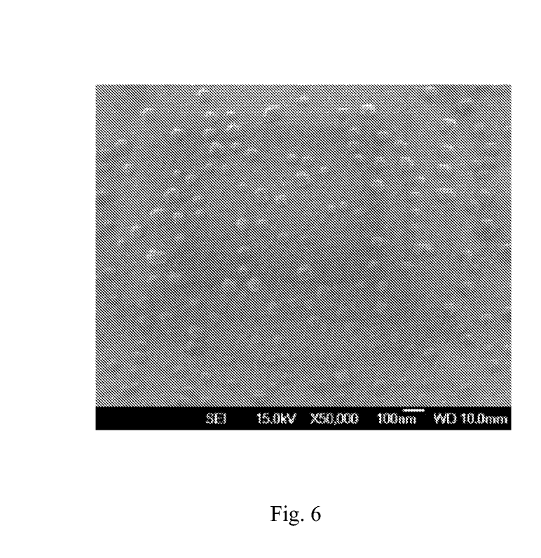

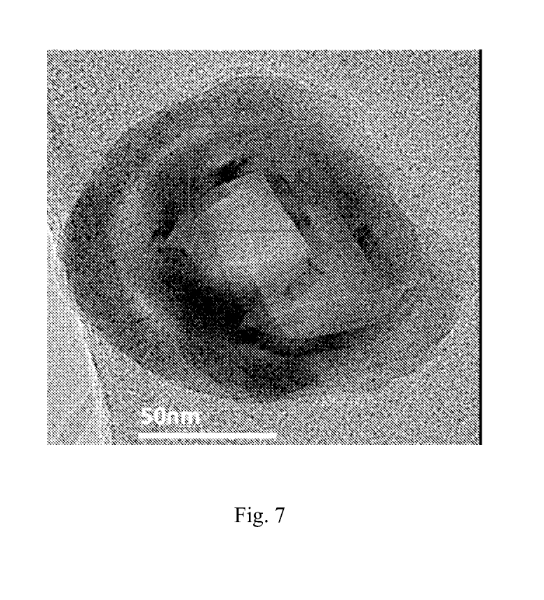

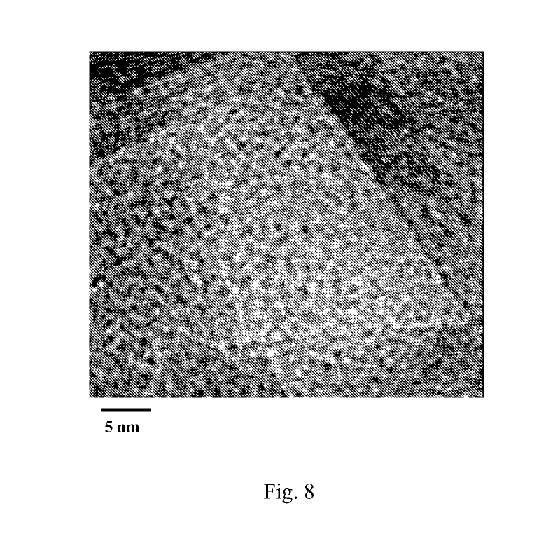

With reference to FIGS. 6 to 8, a scan electron microscopic photograph indicates the hybrid macromolecule is self-assembled in an aqueous environment to form a micelle with diameter by 50 to 100 nanometers. A transmission electron microscopic photograph shows a layered of crystallized silicon dioxide. Accordingly, an internal hydrophobic force pulls atoms of the hybrid macromolecule to self-assemble and organize and to form a layer-by-layered silicon dioxide shell. The silicon dioxide shell is continuous and highly arrangement to form a crystalline-like atomic layer by 4 to 6 nanometers and is a hydrophobic barrier to prevent a drug that is capsuled in the hybrid macromolecule leaking because of the hybrid macromolecule adsorbing water and swelling. The hybrid macromolecule of the invention indicates that it is possible to synthesis a drug carrier under an ambient environment without adding any cross-linking agent.

### Example 3

In this example, a drug of (S)-(+)-camptothecin (CPT) is used to illustrate a method for using the hybrid macromolecule of the invention comprises steps of following:

preparing a drug solution: adding 20 mg CPT into 5 mL DMSO solution and mixing well to form a drug stock solution, and then diluting the drug stock solution by adding a deionizing water to a final concentration of 50 ug/mL and stirring at room temperature for 30 minutes to form a drug solution; and

preparing a drug-contained micelle: adding a hybrid macromolecule of the invention to the drug solution and stirring at room temperature for 24 hours to encapsulate the drug inside of the hybrid macromolecule to form a drug-contained micelle solution, and then centrifuging the drug-contained micelle solution at 8000 rpm at 20° C. and collecting and drying a pellet form the drug-contained micelle solution to gain the drug-contained micelle.

In the step of preparing a drug-contained micelle, the adding amount of the drug depends on the characteristics and type of the drug. In this example, the amount of the CPT is 1.5 mg per ml drug solution.

Drug-release efficiency of the drug-contained micelle of the embodiment is detected by adding the drug-contained micelle in a phosphate buffer saline (PBS) at room temperature for a period, centrifuging the above mentioned solution and detecting the light adsorption to evaluate the release efficiency of CPT.

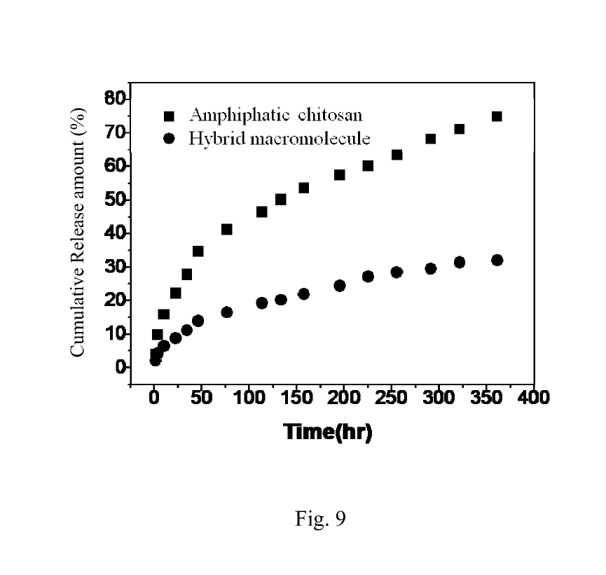

With reference to FIG. 9, the cumulative release amount of CPT decreases with the encapsulated concentration of CPT increasing. It might be associated with the viscosity of CPT. When the encapsulated CPT increasing, the viscosity of the drug solution also increases and affects the self-assembled of the hybrid macromolecule of the invention and decrease the encapsulated amount of CPT. Compare with the conventional amphiphatic chitosan, the drug release of the hybrid macromolecule of the invention is slower due to the silicon dioxide shell of the hybrid macromolecule inhibits drug diffused form the micelle efficiently controls the drug release rate.

### Example 4

A biocompatibility of the CPT micelle of the Example 2 is used to demonstrate the toxicity of the CPT micelle in accordance with the invention.

In this example, a human retinal pigment epithelium APRE-19 (purchased from Bioresource Collection and Research Center, Hsinchu City, Taiwan, BCRC No. 60383), a human lung carcinoma A-549 and a human breast carcinoma MCF-7 are used to detect the toxicity of the CPT micelle. The human retinal pigment epithelium APRE-19 is incubated in an equal volume mixture of DEME medium (dulbecco's modified eagle's medium) and Hans F12 medium contained 1.2 g/L Sodium Bicarbonate., 2.5 mM L-glutamine, 15 mM HEPES, 0.5 mM sodium pyruvate and 10% fetal bovine serum. The human lung carcinoma A-549 is incubated in a DEME medium contained 10% fetal bovine serum. The human breast carcinoma MCF7 is incubated in the DEME medium contained 1% penicillin or streptomycin.

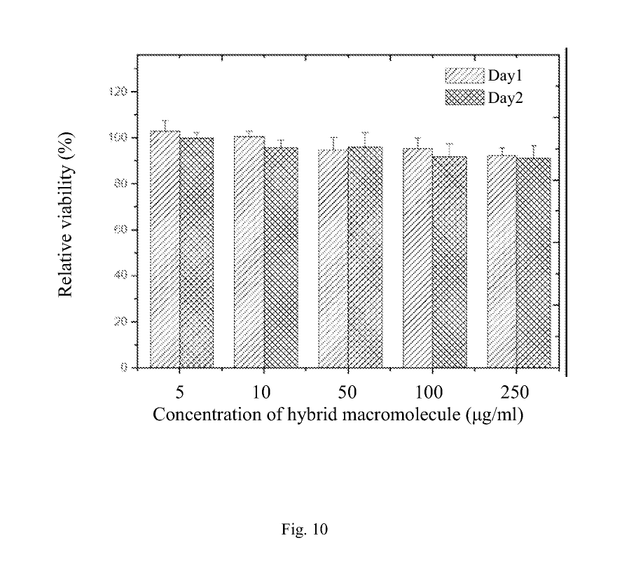

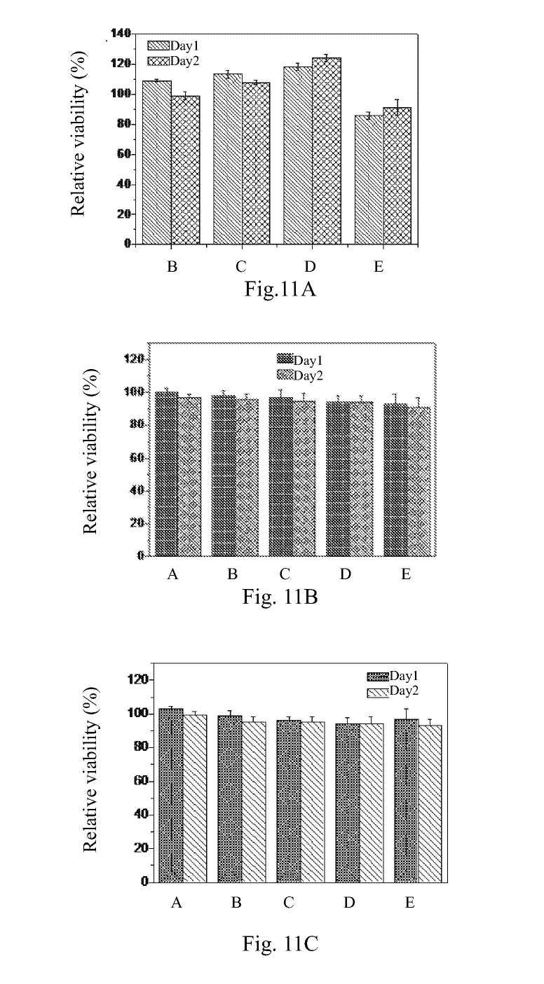

With reference to FIGS. 10, 11A, 11B and 11C, CPT micelles contained different amount CPT (5, 10, 50, 100 and 250 ug/mL) incubate with the human retinal pigment epithelium APRE-19 do not show significant difference in cell growth rate of the human retinal pigment epithelium APRE-19. However, human retinal pigment epithelium APRE-19 incubates with 250 μg/ml of hybrid macromolecules formed by adding different amount of APTES (the mole ratio of carboxymethyl group of the amphiphatic chitosan and the amino group of APTES are 1:1 (line B), 1:2 (line C), 1:5 (line D) and 1:10 (line E), respectively) do not decrease the viability rate with more than 85%. Also, the human lung carcinoma A-549 or the human breast carcinoma MCF-7 incubate with 250 μg/ml of the hybrid macromolecules, formed by adding different amount of APTES, for 2 days have high cell survival rate by more than 90%.

Therefore, the hybrid macromolecule of the present has excellent cell biocompatibility and is not toxic to the cell.

### Example 5

In this example, a drug micelle that is produced by the hybrid macromolecule of the invention and is linked with fluorescein isothiocyanate (FITC) is incubated with the cancer cell for a period and then stains with 4′,6-diamidino-2-phenylindole (DAPI) and rhodamine-phalloidin for detecting the cellular uptake efficiency.

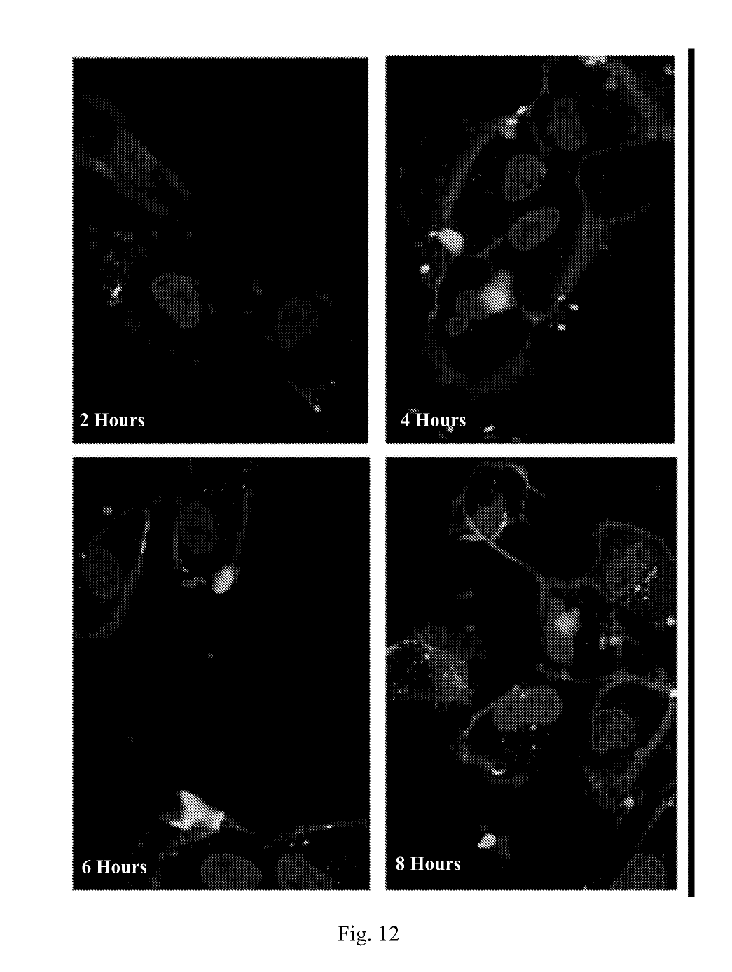

With reference with FIG. 12, a photograph shows the cellular uptake efficiency of the drug micelle. After incubating for 4 hours, there are lots of drug micelles entries into the cytoplasm of the cell. Most drug micelles are uptake by cells at 8^{th} hour. It is obvious that the hybrid macromolecule of the invention is easy to enter into cell so that drugs encapsulated by the hybrid macromolecule will be uptake with the hybrid macromolecule.

Accordingly, the hybrid macromolecule of the invention self-assembles to form a micelle in an aqueous environment and has advantages of excellent biocompatibility and cellular uptake efficiency. The method for producing the hybrid macromolecule of the invention is operated easily. The hybrid macromolecule has great drug loading ability, and is appropriate and has potential to apply as a drug carrier.

While the invention has been described in connection with a number of embodiments and implementations, the invention is not so limited but covers various modifications and equivalent, which fall within the purview of the appended claims. Although features of the invention are expresses in certain combinations among the claims, it is contemplated that these features can be arranged in any combination and order.

What is claimed is:

1. A new-type chitosan-based hybrid macromolecule, being self-assembled to form a micelle in an aqueous environment, comprising
an amphiphatic chitosan comprising at least one carboxymethyl group and having a modified hydrophilic terminal and a modified hydrophobic terminal; and
a silicon-based coupling agent comprising an amino group at least one terminal;
wherein the mole ratio of the carboxymethyl group of the amphiphatic chitosan and the amino group of the silicon-based coupling agent is 1:0.01 to 1:20.

2. The new-type chitosan-based hybrid macromolecule as claimed in claim 1, wherein the hydrophilic terminal being modified by a compound selected form a group consisting of: a molecule contained a carboxymethyl group, a poly ethylene glycol (PEG), a quaternary ammonium compounds and a succinyl group.

3. The new-type chitosan-based hybrid macromolecule as claimed in claim 1, wherein the hydrophobic terminal being modified by a compound selected from a group consists of: hexanoyl, polycaprolactone (PCL), cetyl group, palmitoyl group, cholesteryl group, phthalimido group and butyl glycidol ether.

4. The new-type chitosan-based hybrid macromolecule as claimed in claim 2, wherein the hydrophobic end being modified by a compound selected from a group consists of: hexanoyl, polycaprolactone (PCL), cetyl group, palmitoyl group, cholesteryl group, .phthalimido group and butyl glycidol ether.

5. The new-type chitosan-based hybrid macromolecule as claimed in claim 1, wherein the silicon-based coupling agent being selected from a group consists of 3-Aminopropyltrimethoxysilane (APTMS) and 3-aminopropyltriethoxysilane (APTES).

6. The new-type chitosan-based hybrid macromolecule as claimed in claim 4. wherein the silicon-based coupling agent being selected from a group consists of 3-Aminopropyltrimethoxysilane (APTMS) and 3-aminopropyltriethoxysilane (APTES).

7. The new-type chitosan-based hybrid macromolecule as claimed in claim 1, wherein the silicon-based coupling agent being silicon dioxide.

8. The new-type chitosan-based hybrid macromolecule as claimed in claim 6, wherein the silicon-based coupling agent being silicon dioxide.

9. A method for producing a new-type chitosan-based hybrid macromolecule comprising steps of:
preparing an organic and amphiphatic chitosan solution: adding an organic and amphiphatic chitosan has at least one carboxymethyl group in water and dissolving the amphiphatic chitosan to form the organic and amphiphatic chitosan solution;
preparing an organic and inorganic complex solution: adding a silicon-based coupling agent in the organic and amphiphatic chitosan solution with applying a nitrogen gas and mixing gently to form the organic and inorganic complex solution;
dialysis: dialyzing the organic and inorganic complex solution by a dialysis membrane to form a crude product; and
drying: removing water of the crude product to form the new-type chitosan-based hybrid macromolecule.

10. The method as claimed in claim 9, wherein the organic and amphiphatic chitosan solution being a concentration of 0.1 to 5%.

11. The method as claimed in claim 10, wherein the mole ratio of the carboxymethyl group of the amphiphatic chitosan and the amino group of the silicon-based coupling agent being 1:0.01 to 1:20.

12. The method as claimed in claim 11, wherein the step of preparing an organic and inorganic complex solution comprising a step of
adding a catalyst in the organic and amphiphatic chitosan solution.

13. The method as claimed in claim 12, wherein the catalyst being 1-ethyl-3-(3-dimethylaminopropyl) carbodiimide (EDC).

14. The method as claimed in claim 13, wherein the organic and amphiphatic chitosan comprising
a hydrophilic terminal being modified by a compound selected form a group consists of: a molecule contained a carboxymethyl group, a poly ethylene glycol (PEG), a quaternary ammonium compounds and a succinyl group; and
a hydrophobic terminal being modified by a compound selected from a group consists of: hexanoyl, polycaprolactone (PCL), cetyl group, palmitoyl group, cholesteryl group, phthalimido group and butyl glycidol ether.

15. The method as claimed in claim 14, wherein the silicon-based coupling agent being selected from a group consists of 3-Aminopropyltrimethoxysilane (APTMS) and 3-aminopropyltriethoxysilane (APTES).

16. The method as claimed in claim 14, wherein the step of dialysis using a 20% ethanol solution and dialyzing for at least one day.

17. A method for using a new-type chitosan-based hybrid macromolecule comprising steps of:
preparing a drug solution: dissolving a drug in a solution and mixing well to form a drug stock solution, and then diluting the drug stock solution to form a drug solution; and
preparing a drug-contained micelle: adding a hybrid macromolecule to the drug solution to encapsulate the drug inside of the hybrid macromolecule to form a drug-contained micelle solution, and then centrifuging and drying a pellet form the drug-contained micelle solution to gain the drug-contained micelle.

18. The method as claimed in claim 17, wherein the hybrid macromolecule, being self-assembled to form a micelle in an aqueous environment, comprising
an amphiphatic chitosan comprising at least one carboxymethyl group and having a modified hydrophilic terminal and a modified hydrophobic terminal; and
a silicon-based coupling agent comprising an amino group at least one terminal;
wherein the mole ratio of the carboxymethyl group of the amphiphatic chitosan and the amino group of the silicon-based coupling agent is 1:0.01 to 1:20.

19. The method as claimed in claim 18, wherein the hydrophilic terminal being modified by a compound selected form a group consists of: a molecule contained a carboxymethyl group, a poly ethylene glycol (PEG), a quaternary ammonium compounds and a succinyl group and the hydrophobic terminal being modified by a compound selected from a group consists of hexanoyl, polycaprolactone (PCL), cetyl group, palmitoyl group, cholesteryl group, phthalimido group and butyl glycidol ether.

20. The method as claimed in claim 18, wherein the silicon-based coupling agent being selected from a group consists of 3-Aminopropyltrimethoxysilane (APTMS) and 3-aminopropyltriethoxysilane (APTES).

21. The method as claimed in claim 19, wherein the silicon-based coupling agent being selected from a group consists of 3-Aminopropyltrimethoxysilane (APTMS) and 3-aminopropyltriethoxysilane (APTES).

22. The method as claimed in claim 20, wherein the self-assembled micelle having a diameter by 50 to 500 nanometers.

23. The method as claimed in claim 21, wherein the self-assembled micelle having a diameter by 50 to 500 nanometers.

24. The method as claimed in claim 22, wherein the drug being an anti-cancer drug, an anti-inflammation drug, an anti-hypertension drug, a diabetic drug, a protein drug, a peptide-based drug or a nucleotide.

25. The method as claimed in claim 23, wherein the drug being an anti-cancer drug, an anti-inflammation drug, an anti-hypertension drug, a diabetic drug, a protein drug, a peptide-based drug or a nucleotide.

26. The method as claimed in claim 17, wherein preparing a drug-contained micelle comprising:
stirring the drug solution at room temperature for at least one day.
